(19) United States
(12) Patent Application Publication
(10) Pub. No.: US 2024/0179777 A1
(43) Pub. Date: May 30, 2024

(54) SHORT-RANGE WIRELESS COMMUNICATION METHOD AND ELECTRONIC DEVICE THEREFOR

(71) Applicant: SAMSUNG ELECTRONICS CO., LTD., Suwon-si (KR)

(72) Inventors: Jongmu CHOI, Suwon-si (KR); Junhak LIM, Suwon-si (KR); Doosuk KANG, Suwon-si (KR); Jinwon KIM, Suwon-si (KR); Sangki PARK, Suwon-si (KR); Youngho JEON, Suwon-si (KR); Sinjae KANG, Suwon-si (KR)

(21) Appl. No.: 18/434,471

(22) Filed: Feb. 6, 2024

Related U.S. Application Data
(63) Continuation of application No. PCT/KR2022/010535, filed on Jul. 19, 2022.

(30) Foreign Application Priority Data
Aug. 9, 2021 (KR) 10-2021-0104868

(51) Int. Cl. H04W 76/18; H04W 76/19

(52) U.S. Cl. CPC H04W 76/18; H04W 76/19

(57) ABSTRACT

An electronic device includes: a wireless communication circuit; a memory storing a program including an instruction for performing wireless communication based on a first communication protocol and a second communication protocol, respectively, through the wireless communication circuit; and a processor connected to the memory and the wireless communication circuit to: identify that communication connection of a first communication link is disconnected while performing communication through the first communication link based on the first communication protocol with an external electronic device; with information related to the disconnection of the communication connection, determine if possible to reconnect the first communication link within a specified period of time; and when determined that reconnection of the first communication link is impossible within the specified period of time, connect a second communication link based on the second communication protocol through the wireless communication circuit without waiting for the reconnection for the first communication link.

### CROSS-REFERENCE TO RELATED APPLICATIONS

This application is a continuation application, claiming priority under § 365(c), of International Application No. PCT/KR2022/010535, filed on Jul. 19, 2022, which is based on and claims the benefit of Korean patent application number 10-2021-0104868 filed on Aug. 9, 2021, in the Korean Intellectual Property Office, the disclosures of which are incorporated by reference herein in their entireties.

### TECHNICAL FIELD

Various embodiments disclosed herein relate to an electronic device for performing short-range wireless communication with an external electronic device.

### BACKGROUND ART

With the advancement of technology, electronic devices are reducing in size for easy portability and are evolving to perform various functions in various use forms according to user needs. One example is various forms of wearable devices that are directly attachable to a part of a user's body.

Recently, various electronic devices, including wearable devices, are capable of establishing short-range wireless communication with external electronic devices via at least one of a number of communication protocols and transmitting and receiving various data so as to receive various services.

### DISCLOSURE OF INVENTION

### Technical Problem

An electronic device including a wearable electronic device may communicate with an external electronic device by connecting thereto via a short-range wireless communication protocol, for example, Bluetooth communication, and when the communication with the external electronic device is interrupted, may attempt connection via a different short-range wireless communication protocol, for example, wireless fidelity (Wi-Fi) communication.

When a short-range wireless communication (e.g., Bluetooth) connection is interrupted and thus connection via a different short-range wireless communication (e.g., Wi-Fi) is attempted or established, if connection via the previous short-range wireless communication (e.g., Bluetooth) is possible, the electronic device may perform connection via the previous short-range wireless communication again from the connection via the different short-range wireless communication. In this case, unnecessary communication switching is performed and may lead to battery consumption and additional switching time.

The electronic device may wait for a designated time to switch communication so as to prevent frequent communication connection. However, in this case, the electronic device may be unable to perform communication by waiting for the designated time even though an actual communication breakdown has occurred.

Various embodiments disclosed herein are to provide an electronic device for adaptively controlling communication connection when short-range wireless communication is interrupted in the electronic device, and a method therefor.

The technical task to be achieved by the disclosure is not limited to that mentioned above, and other technical tasks that are not mentioned above may be clearly understood to a person having common knowledge in the technical field to which the disclosure belongs based on the description provided below.

### Solution to Problem

An electronic device according to various embodiments disclosed herein may include at least one wireless communication circuit, a memory configured to store a program including at least one instruction for performing wireless communication based on each of a first communication protocol and a second communication protocol via the at least one wireless communication circuit, and a processor operatively connected to the memory and the wireless communication circuit, wherein the processor is configured to, while performing communication with an external electronic device through a first communication link based on the first communication protocol via at least one wireless communication circuit, identify that a communication connection of the first communication link has been interrupted, based on information related to interruption of the communication connection, determine whether the first communication link is reconnectable within a designated time, and in case that it is determined that reconnection of the first communication link within the designated time is impossible (e.g., a predetermined time has expired), connect a second communication link based on the second communication protocol via the at least one wireless communication circuit without waiting for reconnection of the first communication link.

A method of an electronic device according to various embodiments disclosed herein may include, while performing communication with an external electronic device through a first communication link based on a first communication protocol, identifying that a communication connection of the first communication link has been interrupted, based on information related to interruption of the communication connection, determining whether the first communication link is reconnectable within a designated time, and in case that it is determined that reconnection of the first communication link within the designated time is impossible, connecting a second communication link based on a second communication protocol without waiting for reconnection of the first communication link.

### Advantageous Effects of Invention

According to various embodiments, when a short-range wireless communication is interrupted in an electronic device, the short-range wireless communication connection may be adaptively controlled according to a cause of the interruption.

According to various embodiments, when a short-range wireless communication is interrupted in an electronic device, the short-range wireless communication connection is adaptively controlled according to a cause of the interruption whereby a switching time between short-range wireless communications may be reduced and battery consumption and a communication interruption situation may be decreased.

Various other effects identified directly or indirectly through this document may be provided.

### BRIEF DESCRIPTION OF DRAWINGS

In relation to the description of drawings, the same or similar elements may be indicated by the same or similar reference signs.

FIG. 1 is a block diagram of an electronic device in a network environment according to various embodiments;

FIG. 2 illustrates an example of an appearance of an electronic device for performing short-range wireless communication according to various embodiments;

FIG. 3 is a block diagram of an electronic device for performing short-range wireless communication according to various embodiments;

FIG. 4 is a diagram illustrating a short-range wireless communication operation between an electronic device and an external electronic device according to various embodiments;

FIG. 5 is a flowchart illustrating a method of performing short-range wireless communication by an electronic device according to various embodiments; and

FIG. 6 is a flowchart illustrating an adaptive response operation for interruption of short-range wireless communication of an electronic device according to various embodiments. Mode for the Invention

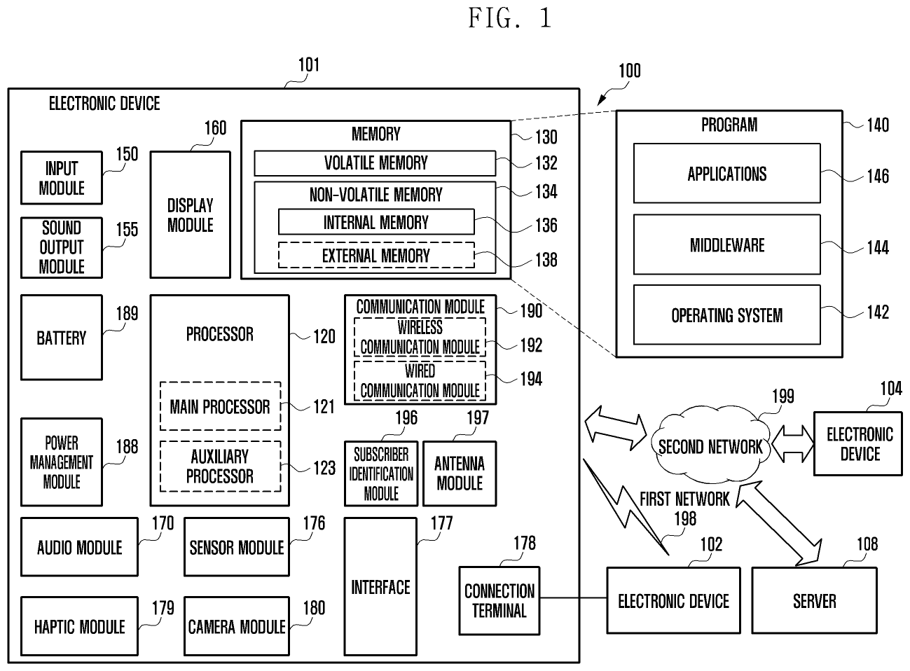

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

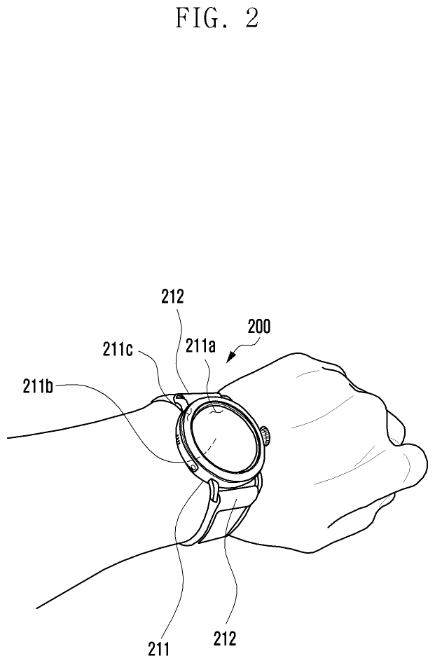

FIG. 2 illustrates an appearance of an electronic device 200 according to various embodiments.

The electronic device 200 (e.g., the electronic device 101 in FIG. 1) illustrated in FIG. 2 is illustrated as a wearable device that is worn on a user's wrist. However, this is an example, and the electronic device 200 is not limited thereto and may include various types of portable electronic devices. For example, the electronic device 200 may include a portable electronic device (e.g., a smartphone or a tablet PC) or a wearable device (e.g., a wireless audio device, a smart watch, or a lost child prevention device) that is capable of short-range wireless communication following at least two types of communication protocols. For example, the electronic device 200 may also be implemented as various wearable devices, such as a body-attached device (e.g., a health patch or a digital tattoo), a clothing-type device (e.g., smart clothing or gloves), or a band-type device (e.g., a wrist/arm/finger band or a smart ring).

Referring to FIG. 2, when implemented as a wearable device, the electronic device 200 may include a housing 211 including a first surface (or front surface) 211a, a second surface (or rear surface) 211b, and a lateral surface 211c surrounding a space between the first surface 211a and the second surface 211b, and a binding member 212 (e.g., a strap) connected to at least a part of the housing 211 and configured to bind the electronic device to be detachably attached to a part (e.g., wrist or ankle) of a user's body.

According to various embodiments, the first surface 211a may be configured by a front plate (e.g., a glass plate or a polymer plate including various coating layers), at least a part of which is substantially transparent.

According to various embodiments, the second surface 211b may be configured by a rear plate that is substantially opaque. The rear plate may be made of, for example, coated or colored glass, ceramic, polymer, metal (e.g., aluminum, stainless steel (STS), or magnesium), or a combination of two or more of the materials.

According to various embodiments, the lateral surface 211c may be configured by a lateral bezel structure (or “lateral member”) that is partially coupled to the front plate (e.g., the first surface 211a) and the rear plate (e.g., the second surface 211b) and includes metal and/or polymer.

According to various embodiments, the rear plate the lateral bezel structure may be integrally configured, and may include the same material (e.g., a metal material such as aluminum). The binding member 212 may be made of various materials and forms. For example, the binding member may be made of a fabric, leather, rubber, urethane, metal, ceramic, or a combination of two or more of the above materials, and may be configured integrally or by multiple unit links that are movable to each other.

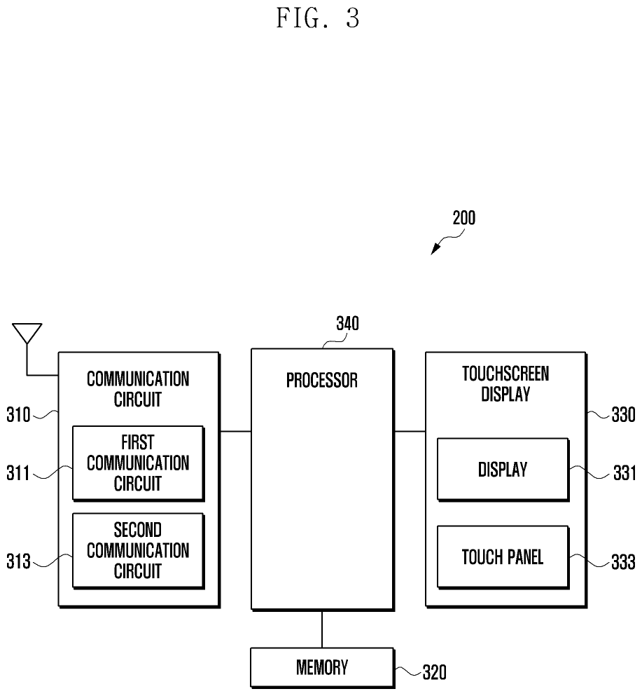

FIG. 3 is a block diagram of an electronic device (e.g., the electronic device 200 in FIG. 2) for performing short-range wireless communication according to various embodiments.

Referring to FIG. 3, the electronic device 200 may include a communication circuit 310 (e.g., the communication module 190 in FIG. 1), a memory 220 (e.g., the memory 130 in FIG. 1), a touchscreen display 230 (e.g., the display device 160 in FIG. 1), and a processor 240 (e.g., the processor 120 in FIG. 1). For example, the electronic device 200 may include at least some elements identical or similar to elements of the electronic device 101 illustrated in FIG. 1.

According to an embodiment, the communication circuit 310 may include a first communication circuit 311 and a second communication circuit 313. According to an embodiment, the first communication circuit 311 may support a first communication protocol, and the second communication circuit 313 may support a second communication protocol. For example, the first communication protocol may include low power short-range communication such as Bluetooth or Bluetooth low energy (BLE). For example, the second communication protocol may include short-range communication (e.g., wireless fidelity (Wi-Fi), Wi-Fi direct, ultra-wideband (UWB), and/or hotspot) except for the first communication protocol. Hereinafter, an example in which the first communication protocol is operated as Bluetooth and the second communication protocol is operated as Wi-Fi will be described for convenience of explanation, but this embodiment is not limited thereto.

In addition, hereinafter, for convenience of explanation, the first communication circuit 311 and the second communication circuit of the electronic device 200 may be distinguishably described as separate elements. However, the first communication circuit 311 and the second communication circuit 313 are not required to be physically distinguished elements, and may be implemented in one communication chip.

According to an embodiment, the memory 320 may store a program and data for establishing communication with an external electronic device (e.g., the electronic device 102 in FIG. 1) via the first communication circuit 311, based on the first communication protocol, and supporting to perform wireless communication. The memory 320 may store a program and data for establishing communication with an external electronic device (e.g., the electronic device 102 in FIG. 1), based on the second protocol and supporting to perform wireless communication. The memory 320 may store a program for displaying, on the touchscreen display 330, data received from an external electronic device connected based on the first communication protocol or the second communication protocol.

According to an embodiment, the touchscreen display 330 may include a display 331 and a touch panel 333, and the display 331 and the touch panel 333 may be integrally configured. The touchscreen display 330 may display images and/or text under the control of the processor 340. The touchscreen display 330 may be implemented as one of a liquid crystal display (LCD), a light-emitting diode (LED) display, an organic light-emitting diode (OLED) display, a micro electro mechanical system (MEMS) display, or an electronic paper display. However, the disclosure is not limited thereto.

According to an embodiment, the display 331 may display a screen for configuring short-range communication (e.g., Bluetooth communication) according to the first communication protocol under the control of the processor 340. The display 331 may display information received from an external electronic device via short-range communication following the first communication protocol, by using an image and/or text under the control of the processor 340. The display 331 may display whether communication has been established based on the second communication protocol, and/or at least one connectable short-range communication device under the control of the processor 340. The touch panel 333 may detect, via the display 331 under the control of the processor 340, a user input for configuring (e.g., communication connection or release) short-range communication according to the first communication protocol and/or configuring (e.g., communication connection or release) short-range communication according to the second communication protocol. According to an embodiment, the processor 340 may detect, through a microphone (not illustrated) from a user, a user input for configuring (e.g., communication connection or release) short-range communication according to the first communication protocol and/or configuring (e.g., communication connection or release) short-range communication according to the second communication protocol.

According to an embodiment, the processor 340 may control overall operations of the electronic device 200 and a signal flow between internal elements of the electronic device 200, perform data processing, and control power supply to the elements from a battery (e.g., the battery 189 in FIG. 1).

An electronic device (e.g., the electronic device 101 in FIG. 1 or the electronic device 200 in FIG. 2 or FIG. 3) according to an embodiment may include at least one wireless communication circuit (e.g., the wireless communication module 192 in FIG. 1 or the communication circuit 310 in FIG. 3), a memory (e.g., the memory 130 in FIG. 1 or the memory 320 in FIG. 3) configured to store a program including at least one instruction for performing wireless communication based on each of a first communication protocol and a second communication protocol via the at least one wireless communication circuit, and a processor (e.g., the processor 120 in FIG. 1 or the processor 340 in FIG. 3) operatively connected to the memory and the wireless communication circuit, wherein the processor is configured to, while performing communication with an external electronic device through a first communication link based on the first communication protocol via the wireless communication circuit, identify that a communication connection of the first communication link has been interrupted, based on information related to interruption of the communication connection, determine whether the first communication link is reconnectable within a designated time, and in case that it is determined that reconnection of the first communication link within the designated time is impossible (e.g., the designated time has expired), connect a second communication link based on the second communication protocol via the wireless communication circuit without waiting for reconnection of the first communication link.

According to an embodiment, the processor may be configured to, in case that it is determined that reconnection of the first communication link within the designated time is possible (e.g., the designated time has not expired yet), delay connection of the second communication link via the wireless communication circuit, and wait for reconnection of the first communication link for the designated time.

According to an embodiment, the processor is configured to, in case that reconnection of the first communication link is not performed until the waiting time passes, connect the second communication link based on the second communication protocol.

According to an embodiment, the processor may be configured to, in case that it is identified, based on the information related to interruption of the communication connection, that a message for communication interruption has been explicitly received from the external electronic device, determine that reconnection of the first communication link within the designated time is impossible.

According to an embodiment, the processor may be configured to, in case that it is identified, based on the information related to interruption of the communication connection, that communication interruption has occurred due to failure in a different communication network of the external electronic device, wait for reconnection of the first communication link for the designated time.

According to an embodiment, the processor may be configured to identify a user pattern, based on the information related to interruption of the communication connection, and in case that it is determined, according to the user pattern, that reconnection of the first communication link within the designated time is impossible, connect the second communication link based on the second communication protocol via the wireless communication circuit.

According to an embodiment, the first communication protocol may be configured to be Bluetooth, and the second communication protocol may be configured to be wireless fidelity (Wi-Fi).

According to an embodiment, the processor may be configured to, in case that it is identified, based on the information related to interruption of the communication connection, that a communication signal quality of a communication interruption time point is a designated level or higher, delay connection of the second communication link, and wait for reconnection of the first communication link for the designated time.

According to an embodiment, the processor may be configured to, in case that it is identified, based on the information related to interruption of the communication connection, that the communication signal quality of the communication interruption time point is lower than the designated level, connect the second communication link based on the second communication protocol without waiting for reconnection of the first communication link via the wireless communication circuit.

According to an embodiment, the information related to interruption of the communication connection may include at least one of state information, app information, user behavior pattern information, message information, communication state information, communication quality information, or communication connection-related control information of the external electronic device.

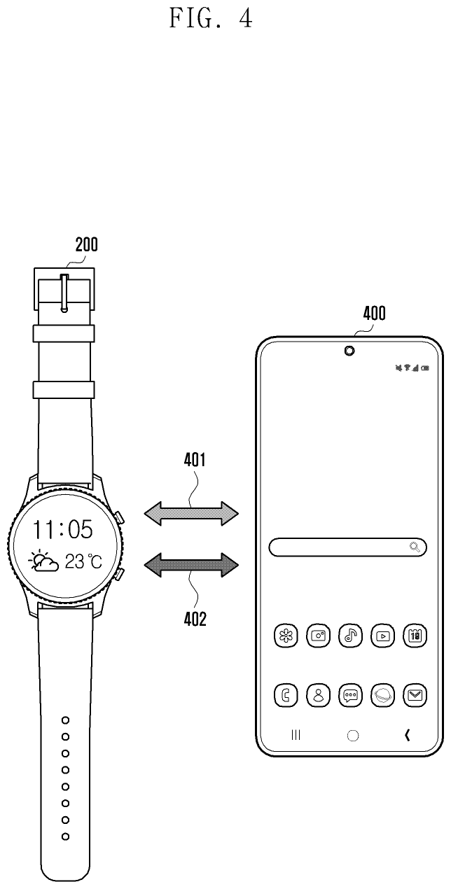

FIG. 4 is a diagram illustrating a short-range wireless communication operation between an electronic device (e.g., the electronic device 200 in FIG. 2 or FIG. 3) and an external electronic device 400 (e.g., the electronic device 102 in FIG. 1) according to various embodiments. Hereinafter, various embodiments will be described in detail with reference to FIG. 3 and FIG. 4.

According to an embodiment, the external electronic device 400 may include an electronic device (e.g., the electronic device 102 in FIG. 1) capable of short-range wireless communication following at least two types of different communication protocols. For example, the external electronic device 400 may include a portable communication device (e.g., a smartphone), a computer device, a portable multimedia device, a camera, a wearable device, or a home appliance. The external electronic device 400 according to an embodiment disclosed herein is not limited to the above devices.

According to an embodiment, the external electronic device 400 may include at least some elements identical or similar to elements of the electronic device 101 illustrated in FIG. 1. For example, the external electronic device 400 may include a wireless communication module (e.g., the wireless communication module 194 in FIG. 1). The external electronic device 400 may perform short-range wireless communication including Bluetooth or Bluetooth low energy (BLE), wireless fidelity (Wi-Fi), Wi-Fi direct, ultra-wideband (UWB), and/or hotspot via the wireless communication module. The external electronic device 400 may communicate with another electronic device (e.g., the electronic device 104 or the server 108 in FIG. 1) via a long-range communication network, such as a legacy cellular network, a 5G network and a next generation communication technology beyond 4G, for example, a new radio (NR) access technology, the Internet, or a computer network (e.g., LAN or WAN).

According to an embodiment, the electronic device 200 may connect a first communication link 401 based on a first communication protocol or a second communication link 402 based on a second communication protocol to the external electronic device 400, and perform short-range wireless communication.

According to an embodiment, the processor 340 of the electronic device 200 may establish a connection with the external electronic device 400 through the first communication link 401 via the first communication circuit 311, based on the first communication protocol, and transmit or receive data. For example, when the first communication protocol is a Bluetooth or BLE communication protocol, this communication protocol consumes small current and is thus able to maintain communication for a relatively long time even with a small battery capacity.

According to an embodiment, when the first communication protocol is implemented as Bluetooth, the electronic device 200 may store identification information (e.g., device unique information (device unique identifier) or a device address) of the external electronic device 400 in the memory 320. For example, the electronic device 200 may, when initial connection is established, receive information including identification information of the external electronic device 400 via short-range wireless communication with the external electronic device 400 using the first communication circuit 311. For example, the external electronic device 400 may receive identification information (e.g., device unique information or a device address) of the electronic device 200 via short-range wireless communication with the electronic device 200. For example, the electronic device 200 may transmit an advertisement packet to establish communication with the external electronic device 400. For example, the electronic device 200 may transmit an advertisement packet and then transmit a scan response for a scan request received from the external electronic device 400, to establish communication with the external electronic device 400. For example, an advertisement packet, a scan request packet, and/or a scan response packet may include device identification information (e.g., device unique information or a device address). For example, the electronic device 200 may obtain identification information of the external electronic device 400 from a scan request packet received from the external electronic device 400.

Hereinafter, a case where, in short-range wireless communication with the external electronic device 400, the processor 340 of the electronic device 200 preferentially applies connecting the first communication link 401 and performing communication, based on the first communication protocol may be described as an example.

According to an embodiment, the processor 340 may identify whether communication through the first communication link 401 via the first communication circuit 311 has been interrupted. Here, communication interruption may include various cases in which communication using a communication link becomes impossible. For example, communication interruption may include a case where a physical communication link of the first communication link 401 is cut off, or various cases where actual communication is impossible even though a physical link is connected. For example, the electronic device 200 may determine that communication has been interrupted, when a communication connection with the external electronic device 400 is released. As another example, the electronic device 200 may determine that communication has been interrupted, in a case where communication quality is equal to or lower than a designated level, the case including a case where, during communication with the external electronic device 400, the electronic device has failed to receive a packet from the external electronic device 400 for a designated time or longer, or the number of received packets is smaller than a designated threshold. However, even if communication interruption through the first communication link 401 has not occurred, the processor 340 may, if necessary, connect the second communication link 402 in addition to or in replacement of the first communication link 401 and perform communication. Communication interruption of the first communication link 401, additional connection of the second communication link 402, or connection of the second communication link 402 in replacement of the first communication link 401 may be performed in a combination of one or more of them.

According to an embodiment, when communication through the first communication link 401 is interrupted, the processor 340 may identify a reason for the communication interruption, and based on the reason, control the first communication circuit 311 and/or the second communication circuit 313 to switch to a waiting state for reconnection of the first communication link 401 based on the first communication protocol, or switch to communication based on the second communication protocol.

Here, a communication switch operation may include, for example, a case of switching, from an OFF state (e.g., a deactivated state or sleep state) to an ON state (e.g., an active state or wakeup state), at least some of functions of the second communication circuit 313 that is an element for second communication protocol communication of the electronic device 200, and establishing an access and configuring a connection to the second communication link 402 via the second communication circuit 313. For example, a communication switch operation may include an operation of triggering a connection to the external electronic device 400 in a state where the second communication circuit 313 of the electronic device 200 is turned on or a program for operating the second communication protocol is activated. For example, a communication switch operation may include an operation of switching communication, which is established by connection of the second communication link 402 via the second communication protocol, to a preferential short-range wireless communication scheme in a state where communication, which is established by connection of the first communication link 401 via the first communication protocol, is configured as the preferential short-range wireless communication scheme in the electronic device 200.

According to an embodiment, for connection of the first communication link 401 with the external electronic device 400, based on the first communication protocol, the processor 340 of the electronic device 200 may store various information such as address information and identification information (e.g., name) received from the external electronic device at the time of initial connection and then, if reconnection is required, may quickly re-establish connection through the stored information.

According to an embodiment, the processor 340 of the electronic device 200 may receive, through the first communication link 401, various information including information on various apps performed in the external electronic device 400, user behavior pattern information collected by the external electronic device, information on a message received by the external electronic device, state information (e.g., on/off) of the external electronic device, battery level information, communication state and/or communication quality information of the external electronic device, based on various communication protocols, or control information related to communication connection or interruption. Various information received by the processor 340 of the electronic device 200 via the external electronic device 400 through the first communication link 401 may be used, for example, as training data for machine learning, or used to output control data for controlling short-range wireless communication connection of the electronic device 200, through a machine learning training model.

According to an embodiment, the processor 340 may display image and/or text information on the display 331, based on information received from the external electronic device 400. When user configuration or control information on various functions of the electronic device 200 or the external electronic device 400 is input based on image and/or text information displayed on the display 331, the processor 340 may transfer data related to the user configuration or control information to the external electronic device 400.

According to an embodiment, the processor 340 may receive information related to connection or interruption of a physical link of the first communication link 401 from the first communication circuit 311, based on a signal received from the external electronic device 400, based on the first communication protocol, and determine whether communication of the first communication link 401 has been interrupted. For example, when the first communication circuit 311 notifies that a physical link connection of the first communication link 401 has been interrupted or that detection of a signal received from the external electronic device 400 has failed for a designated time (e.g., 10 seconds), the processor 340 may determine that communication of the first communication link 401 has been interrupted.

According to an embodiment, the processor 340 may identify an interruption reason for communication interruption of the first communication link 401 notified from the first communication circuit 311 and, based on the interruption reason, wait for communication reconnection through the first communication link 401 or perform communication switching to a connection of the second communication link 402 based on the second communication protocol via the second communication circuit 313.

According to an embodiment, the processor 340 may identify whether a communication connection through the first communication link 401 has been explicitly interrupted. For example, the processor 340 may receive, via the first communication circuit 311, a command or message of interrupting the first communication link 401 made by the external electronic device 400, and in this case, identify that a communication connection has been explicitly interrupted. For example, the processor 340 may receive an interruption command for the first communication link 401 with the external electronic device 400 via the touch panel 333, and in this case, identify that a communication connection has been explicitly interrupted.

If a communication connection through the first communication link 401 has been explicitly interrupted, it may be difficult that the communication connection is re-established within a designated time that communication is normally performed/expected. According to an embodiment, when it is identified that the first communication link 401 has been explicitly interrupted, the processor 340 may not wait for communication reconnection of the first communication link 401, and immediately activate the second communication circuit 313 and establish a communication connection through the second communication link 402 to perform communication.

According to an embodiment, when communication interruption occurs, the processor 340 may identify state information of the external electronic device 400, for example, communication state and/or communication quality information corresponding to various communication protocols, the information being received from the external electronic device 400, and wait for communication reconnection through the first communication link 401 or perform communication switching through the second communication link 402 according to whether failure in a different communication network incurred by the external electronic device 400 is temporary or not. For example, communication network failure may be determined as being temporary in a case where a bearer (or mode) is switched on a communication network over which the external electronic device 400 communicates with the other electronic device 104 or the server 108, or in a case where communication is temporarily unstable due to entry to a weak electric field in a communication network-connected state. As another example, in a case where the external electronic device 400 enters a service restricted area or is switched to an airplane mode or a Do Not Disturb mode, communication network failure may be determined as not being temporary.

According to an embodiment, when communication interruption occurs, the processor 340 may identify various user patterns collected autonomously by the electronic device 200 or from the external electronic device 400, and respond to the communication interruption according to the various user patterns. For example, the processor 340 may identify a user pattern in which the distance between a user and the external electronic device 400 increases at a corresponding time and/or place, based on the time and/or place at which communication interruption occurs. For example, the processor may identify a user pattern according to a Bixby® routine configured via the electronic device 200 or the external electronic device 400. For example, the processor may identify a user pattern, configured in the electronic device 200, of switching to an inactive mode, such as an airplane mode and/or a Do Not Disturb mode, so as not to receive a message from the external electronic device 400, or a user pattern, configured in the external electronic device 400, for switching to an inactive mode, such as an airplane mode and/or a Do Not Disturb mode. For example, the processor may identify a statistical user pattern for a user's sleep state configured in the electronic device 200 or obtained by the electronic device 200.

According to an embodiment, the processor 340 may identify a user pattern for which re-establishment of connection of the first communication link 401 within a designated time is difficult, and if the user pattern is identified, may immediately perform communication switching through the second communication link 402.

According to an embodiment, the processor 340 may, when communication interruption occurs, identify whether a communication quality (e.g., reference signal received power (RSRP), reference received quality (RSRQ), or received signal strength indication (RSSI)) of a signal received lastly from the external electronic device 400 is smaller than a designated value, to identify a communication quality condition. For example, when communication with the external electronic device 400 is rapidly interrupted and thus a lastly measured communication quality condition is equal to or greater than a designated quality condition, the processor determines that the communication interruption is caused by rapid communication failure, and determine that a communication connection will be resumed within a relatively designated time. For example, if a communication connection is interrupted as communication quality is gradually lowered, the processor may determine that the occurrence of the communication interruption is due to the increasing distance from the external electronic device 400, and thus determine that it is difficult to expect resumption of the communication connection within a designated time. For example, when the electronic device 200 supports a communication protocol, such as UWB communication, in which distance measurement is possible, the processor may identify whether communication interruption has occurred due to an increasing distance, by using the communication protocol. When a signal quality of a time point at which communication interruption occurs is lower than a designated quality condition, the processor 340 may immediately perform communication switching through the second communication link 402.

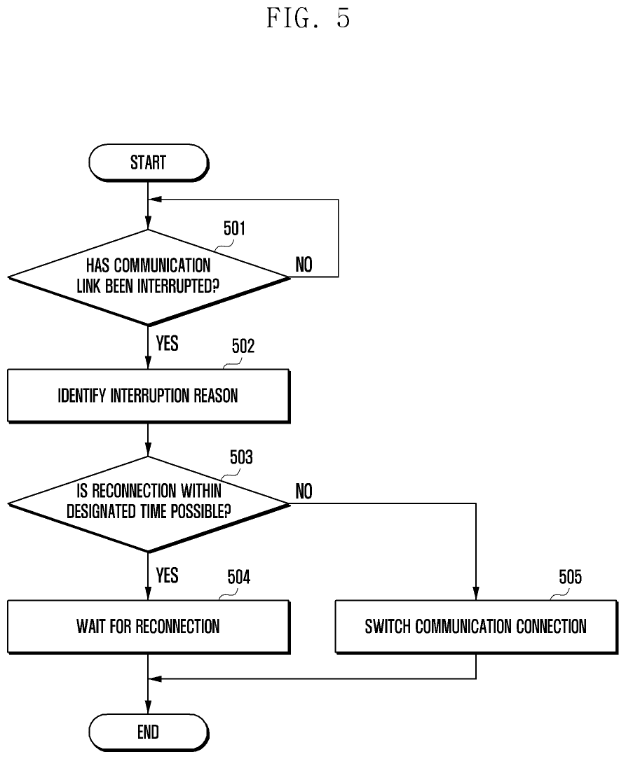

FIG. 5 is a flowchart illustrating a method of performing short-range wireless communication between an electronic device (e.g., the electronic device 200 in FIG. 2, FIG. 3, or FIG. 4) and an external electronic device (e.g., the electronic device 400 in FIG. 4) according to various embodiments.

According to an embodiment, the electronic device 200 may perform short-range wireless communication with the external electronic device 400 through a first communication link based on a first communication protocol or a second communication link based on a second communication protocol.

According to an embodiment, a processor (e.g., the processor 340 in FIG. 2) of the electronic device 200 may, in operation 501, identify whether communication has been interrupted, while performing the communication with the external electronic device 400 through the first communication link, based on the first communication protocol. For example, the processor 340 may identify that communication has been interrupted, in various cases in which communication using the first communication link becomes impossible. For example, the processor 340 may identify that communication has been interrupted, in a case where a physical communication link of the first communication link is released, packet reception from the external electronic device 400 fails for a designated time or longer, or a communication quality is equal to or lower than a designated level and thus actual communication is impossible.

According to an embodiment, when communication through the first communication link is interrupted, the processor 340 may identify a reason for the communication interruption in operation 502. According to an embodiment, the processor 340 may, in operation 503, determine whether communication through the first communication link is resumable, based on the reason for the communication interruption. For example, the processor 340 may determine whether the first communication link is reconnectable within a designated time (e.g., 5 to 30 seconds).

According to an embodiment, the processor 340 may receive, through the first communication link, various information including execution information on various apps performed in the external electronic device 400, user behavior pattern information collected by the external electronic device 400, information on a message received by the external electronic device 400, state information (e.g., on/off) of the external electronic device, battery level information, communication state and/or communication quality information of the external electronic device, based on various communication protocols, or control information related to communication network connection or disconnection. According to various embodiments, the processor 340 may identify a reason for communication interruption, based on various information received from the external electronic device 400. For example, the processor 340 may identify a reason for communication interruption, based on various information received from the external electronic device 400, immediately before a communication link is interrupted, or a predetermined time before the communication link is interrupted.

According to an embodiment, if it is identified that a communication connection of the first communication link has been explicitly interrupted by a control signal from the external electronic device 400, the processor 340 may determine that there is a low possibility of communication resumption through the first communication link. For example, if a command or message of interrupting the first communication link made by the external electronic device 400 is received, the processor 340 may identify that the communication connection has been explicitly interrupted.

According to an embodiment, the processor 340 may determine a communication resumption possibility by determining, based on state information, and communication state and/or communication quality information of the external electronic device 400, whether communication interruption of the first communication link is caused by communication network failure of the external electronic device 400 and, if the communication interruption is caused by the communication network failure, whether the communication network failure is a temporary communication failure.

According to an embodiment, the processor 340 may determine whether a possibility that interrupted communication of the first communication link is resumed within a designated time is high according to a collected user pattern.

According to an embodiment, the processor 340 may determine whether a possibility of communication resumption within a designated time is high, based on the quality of a communication signal for the external electronic device 400 at a time point at which communication interruption of the first communication link has occurred. For example, when a communication quality is higher than a designated quality condition, the processor may determine that a possibility of communication resumption within a designated time is high.

According to an embodiment, when it is determined that communication through the first communication link is resumable within a designated time, the processor 340 may wait for reconnection of the first communication link in operation 504. For example, the processor 340 may, for a designated time, wait to receive a packet for connection of the first communication link or periodically transmit an advertisement packet for connection of the first communication link. If reconnection of the first communication link is not performed until a designated waiting time passes after waiting for a designated time, the processor 340 may establish a connection of the second communication link, based on the second communication protocol.

According to an embodiment, when it is determined that communication through the first communication link is not resumable within a designated time, the processor 340 may switch communication connection in operation 505. For example, the processor 340 may establish a connection of the second communication link via the second communication protocol. The processor 340 may switch a second communication circuit (e.g., the second communication circuit 323 in FIG. 3) to an ON state, and establish an access to and configure a connection of the second communication link via the second communication circuit 323. For example, the processor 340 may trigger a connection with the external electronic device 400 in a state where the second communication circuit is activated. According to an embodiment, the processor 340 may configure to switch communication caused by connection of the second communication link via the second communication protocol, as a preferential short-range wireless communication scheme of the electronic device 200. In this case, the processor 340 may stop transmission of an advertisement packet, based on the first communication protocol, or stop attempting to receive a packet for connection of the first communication link.

According to an embodiment, the processor 340 may identify whether a communication connection through the first communication link 401 has been explicitly interrupted. For example, the processor 340 may receive, via the first communication circuit 311, a command or message of interrupting the first communication link 401 made by the external electronic device 400, and in this case, identify that a communication connection has been explicitly interrupted. As another example, the processor 340 may receive an interruption command for the first communication link 401 with the external electronic device 400 via the touch panel 533, and in this case, identify that a communication connection has been explicitly interrupted.

If a communication connection through the first communication link 401 has been explicitly interrupted, it may be difficult that the communication connection is re-established within a designated time that communication is normally performed. According to an embodiment, when it is identified that the first communication link 401 has been explicitly interrupted, the processor 340 may not wait for communication reconnection, and immediately activate the second communication circuit 313 and establish a communication connection through the second communication link 402 to perform communication.

According to an embodiment, when communication interruption occurs, the processor 340 may identify state information of the external electronic device 400, for example, communication state and/or communication quality information corresponding to various communication protocols, the information being received from the external electronic device 400, and wait for communication reconnection through the first communication link 401 or perform communication switching through the second communication link 402 according to whether failure in a different communication network incurred by the external electronic device 400 is temporary or not. For example, communication network failure may be determined as being temporary in a case where a bearer is switched on a communication network over which the external electronic device 400 communicates with the other electronic device 104 or the server 108, or in a case where communication is temporarily unstable due to entry to a weak electric field in a communication network-connected state. As another example, in a case where the external electronic device 400 enters a service restricted area or is switched to an airplane mode or a Do Not Disturb mode, communication network failure may be determined as not being temporary.

According to an embodiment, when communication interruption occurs, the processor 340 may identify a user pattern collected autonomously by the electronic device 200 or from the external electronic device 400, and respond to the communication interruption according to the user pattern. For example, the processor 340 may identify a user pattern in which the distance between a user and the external electronic device 400 increases at a corresponding time and/or a place, based on the time and/or place at which communication interruption occurs, or a user pattern of switching to an inactive mode, such as an airplane mode or a Do Not Disturb mode, so as not to receive a message from the external electronic device 400. According to an embodiment, in a case where the external electronic device 400 switches to an airplane mode or a Do Not Disturb mode, the external electronic device may notify, through the first communication link 401, the electronic device 200 that the external electronic device has switched to a non-active mode.

According to an embodiment, the processor 340 may identify a user pattern for which re-establishment of connection of the first communication link 401 within a designated time is difficult, and if the user pattern is identified, may immediately perform communication switching through the second communication link 402.

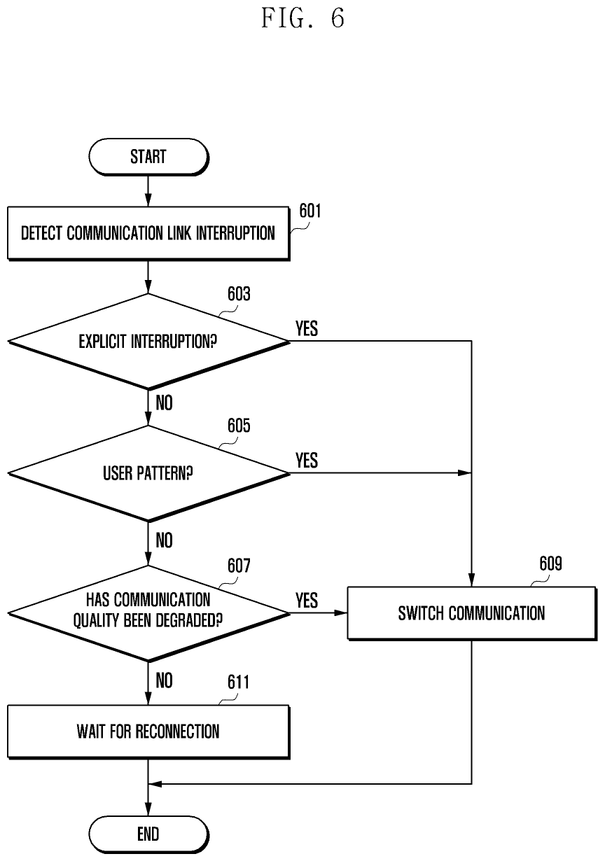

According to an embodiment, the processor 340 may, when communication interruption occurs, identify a communication quality condition, based on a communication quality (e.g., reference signal received power (RSRP), reference received quality (RSRQ), or received signal strength indication (RSSI)) of a signal received lastly from the external electronic device 400. For example, when communication with the external electronic device 400 is rapidly interrupted, the processor may determine whether expecting resumption of a communication connection within a designated time is possible, based on a lastly measured communication quality condition, and may, based on the determination, immediately perform communication switching or wait communication reconnection for the designated time. According to an embodiment, the processor 340 may identify an hourly variance of a signal received from the external electronic device 400, and when the hourly variance is equal to or greater than a threshold, may determine that communication has been rapidly interrupted and thus a communication connection is resumable within a designated time. FIG. 6 is a flowchart illustrating an adaptive response operation for interruption of short-range wireless communication between an electronic device (e.g., the electronic device 200 in FIG. 2, FIG. 3, or FIG. 4) and an external electronic device (e.g., the electronic device 400 in FIG. 4) according to various embodiments.

According to an embodiment, while performing short-range wireless communication with the external electronic device 400 through a first communication link based on a first communication protocol, the electronic device 200 may detect that interruption of the communication link has occurred, in operation 601.

According to an embodiment, a processor (e.g., the processor 340 in FIG. 2) of the electronic device 200 may, when communication interruption occurs, identify a reason why performing communication is not possible, by using the first communication link. The processor 340 may identify, based on the reason for communication interruption, whether communication through the first communication link is resumable within a designated time, and then adaptively perform short-range communication accordingly.

According to an embodiment, the electronic device 200 may, in operation 603, identify whether communication of the first communication link has been explicitly interrupted. For example, if a command or message of interrupting the first communication link made by the external electronic device 400 is received, the processor 340 may identify that the communication connection has been explicitly interrupted. As another example, when an input for interrupting the first communication link or switching to a second communication link is received from a user via the touchscreen display 330 or the microphone (not illustrated), the processor 340 may identify that the communication connection has been explicitly interrupted.

According to an embodiment, when the first communication link has been explicitly interrupted, the electronic device 200 may proceed to operation 609 and perform communication switching to the second communication link based on a second communication protocol. For example, when the second communication protocol is Wi-Fi, the electronic device 200 may transmit an authentication message for connection of the second communication link with the external electronic device 400, and then perform an association request (association) operation to connect the second communication link. In an embodiment, if a Wi-Fi authentication process has already been performed, the electronic device 200 may immediately perform an association request operation to connect the second communication link. For example, for rapid communication link connection, the electronic device 200 may receive and store, at initial connection, information of the external electronic device 400, for example, information required for communication connection, such as a basic service set identifier (BSSID), a service set identifier (SSID), and security-type information.

According to an embodiment, when communication interruption of the first communication link is not an explicit interruption, the processor 340 may, in operation 605, identify a user pattern of the electronic device 200 and/or the external electronic device 400 to determine a communication interruption reason. The processor 340 may determine whether the communication interruption of the first communication link will continue for a predetermined time or longer, according to the identified user pattern. When a user pattern is identified and thus it is determined that the communication interruption of the first communication link will continue for the predetermined time or longer, the processor 340 may proceed to operation 609 and perform communication switching to the second communication link, based on the second communication protocol.

According to an embodiment, when the communication interruption reason does not correspond to a user pattern, the processor 340 may, in operation 607, identify a communication quality of a communication interruption time point, and when it is identified that the communication quality has been degraded below a designated condition, proceed to operation 609 and perform communication switching to the second communication link based on the second communication protocol.

According to an embodiment, a case where a communication quality has been degraded below a designated condition may include a case where failure has occurred in the entire communication network of the external electronic device 400 including the first communication link. In this case, the processor may determine whether communication interruption of the first communication link is caused by a communication problem of the external electronic device 400 including communication network failure of the external electronic device 400, based on state information, and communication state and/or communication quality information of the external electronic device 400. For example, in a case where the first communication link is interrupted due to a communication problem of the external electronic device 400, such as the entire communication network failure of the external electronic device 400, even if the second communication link is connected, communication interruption may still occur and subsequent communication switching to the first communication link may occur again. Therefore, such frequent communication switching may cause battery consumption and an additional switching time. In this case, the processor 340 may proceed to operation 611 and wait for a designated time for reconnection of communication through the first communication link.

According to an embodiment, the processor 340 may, in operation 607, identify a communication quality of a communication interruption time point, and when it is identified that the communication quality is equal to or higher than the designated condition, proceed to operation 611 and wait for a designated time for connection of communication through the first communication link. For example, the processor 340 may, for a designated time, wait to receive a packet for connection of the first communication link or periodically transmit an advertisement packet for connection of the first communication link.

According to an embodiment, a case where the first communication link has been degraded even though a communication quality is equal to or higher than a designated condition may include a case where the degradation is caused by a different temporary communication network failure of the external electronic device 400. In this case, the processor 340 of the electronic device 200 may wait for reconnection of the first communication link for a designated time.

According to an embodiment, in operation 607, when communication quality degradation occurs, the processor 340 may identify an hourly variance of a signal received from the external electronic device 400 and perform operation 609 or operation 611. For example, when an hourly variance of a signal received from the external electronic device 400 is equal to or greater than a threshold (e.g., communication quality degradation has occurred due to rapid communication interruption), the processor 340 may determine that the communication connection is resumable within a designated time, proceed to operation 611, and wait for reconnection of communication through the first communication link for the designated time.

A communication link connection control method described above with reference to FIG. 6 is not limited to the above description, and the order of each operation may be changed from each other, a particular operation may be omitted, or operations may be performed in combination according to various sequences.

A method of an electronic device (e.g., the electronic device 101 in FIG. 1 or the electronic device 200 in FIG. 2, FIG. 3, or FIG. 4) according to an embodiment may include, while performing communication with an external electronic device (e.g., the electronic device 400 in FIG. 4) through a first communication link based on a first communication protocol, identifying that a communication connection of the first communication link has been interrupted, based on information related to interruption of the communication connection, determining whether the first communication link is reconnectable within a designated time, and in case that it is determined that reconnection of the first communication link within the designated time is impossible, connecting a second communication link based on a second communication protocol without waiting for reconnection of the first communication link.

According to an embodiment, the method may further include, in case that it is determined that reconnection of the first communication link within the designated time is possible, delaying connection of the second communication link, and waiting for reconnection of the first communication link for the designated time.

According to an embodiment, in case that reconnection of the first communication link is not performed until the waiting time passes, the second communication link based on the second communication protocol may be connected.

According to an embodiment, the method may further include, in case that it is identified, based on the information related to interruption of the communication connection, that a message for communication interruption has been explicitly received from the external electronic device, determining that reconnection of the first communication link within the designated time is impossible.

According to an embodiment, the method may further include, in case that it is identified, based on the information related to interruption of the communication connection, that communication interruption has occurred due to failure in a different communication network of the external electronic device, waiting for reconnection of the first communication link for the designated time.

According to an embodiment, the method may include identifying a user pattern, based on the information related to interruption of the communication connection, and in case that it is determined, according to the user pattern, that reconnection of the first communication link within the designated time is impossible, connecting the second communication link based on the second communication protocol.

According to an embodiment, the first communication protocol may be configured to be Bluetooth, and the second communication protocol may be configured to be wireless fidelity (Wi-Fi).

According to an embodiment, the method may further include, in case that it is identified, based on the information related to interruption of the communication connection, that a communication signal quality of a communication interruption time point is a designated level or higher, delaying connection of the second communication link and waiting for reconnection of the first communication link for the designated time.

According to an embodiment, the method may include, in case that it is identified, based on the information related to interruption of the communication connection, that the communication signal quality of the communication interruption time point is lower than the designated level, connecting the second communication link based on the second communication protocol without waiting for reconnection of the first communication link.

According to an embodiment, the information related to interruption of the communication connection may include at least one of state information, app information, user behavior pattern information, message information, communication state information, communication quality information, or communication connection-related control information of the external electronic device. The embodiments disclosed herein are merely presented to easily describe technical content and help the understanding of same and are not intended to limit the technical scope disclosed therein. Therefore, the technical scope disclosed therein should be construed to include, in addition to the embodiments disclosed herein, all changes and modifications that are derived based on the technical idea of various embodiments disclosed herein.

What is claimed is:

1. An electronic device comprising:
at least one wireless communication circuit;
memory configured to store a program including at least one instruction for performing wireless communication based on each of a first communication protocol and a second communication protocol via the at least one wireless communication circuit; and
a processor operatively connected to the memory and the wireless communication circuit,
wherein the memory stores instructions which, when executed by the processor, cause the electronic device to:
while performing communication with an external electronic device through a first communication link based on the first communication protocol via the at least one wireless communication circuit, identify that a communication connection of the first communication link has been interrupted;
based on information related to interruption of the communication connection, determine whether the first communication link is reconnectable within a designated time; and
in response to determining that reconnection of the first communication link within the designated time is impossible, connect a second communication link based on the second communication protocol via the at least one wireless communication circuit without waiting for the reconnection of the first communication link.

2. The electronic device of claim 1, wherein the memory stores further instructions which, when executed by the processor, cause the electronic device to, in response to determining that the reconnection of the first communication link within the designated time is possible, delay connection of the second communication link via the at least one wireless communication circuit, and wait for the reconnection of the first communication link for the designated time.

3. The electronic device of claim 2, wherein the memory stores further instructions which, when executed by the processor, cause the electronic device to, in response to the reconnection of the first communication link not being performed before the designated time passes, connect the second communication link based on the second communication protocol.

4. The electronic device of claim 1, wherein the memory stores further instructions which, when executed by the processor, cause the electronic device to, based on the information related to interruption of the communication connection identifying that a message for communication interruption has been explicitly received from the external electronic device, determine that the reconnection of the first communication link within the designated time is impossible.

5. The electronic device of claim 1, wherein the memory stores further instructions which, when executed by the processor, cause the electronic device to, based on the information related to interruption of the communication connection identifying that communication interruption has occurred due to failure in a different communication network of the external electronic device, wait for the reconnection of the first communication link for the designated time.

6. The electronic device of claim 1, wherein the memory stores further instructions which, when executed by the processor, cause the electronic device to:
identify a user pattern, based on the information related to interruption of the communication connection, and
in response to determining according to the user pattern that the reconnection of the first communication link within the designated time is impossible, connect the second communication link based on the second communication protocol via the at least one wireless communication circuit.

7. The electronic device of claim 1, wherein the memory stores further instructions which, when executed by the processor, cause the electronic device to, based on the information related to interruption of the communication connection identifying that a communication signal quality of a communication interruption time point is a designated level or higher, delay connection of the second communication link, and wait for the reconnection of the first communication link for the designated time.

8. The electronic device of claim 1, wherein the memory stores further instructions which, when executed by the processor, cause the electronic device to, based on the information related to interruption of the communication connection identifying that a communication signal quality of a communication interruption time point is lower than a designated level, connect the second communication link based on the second communication protocol without waiting for the reconnection of the first communication link.

9. The electronic device of claim 1, wherein the information related to interruption of the communication connection comprises at least one of state information, app information, user behavior pattern information, message information, communication state information, communication quality information, or communication connection-related control information of the external electronic device.

10. The electronic device of claim 1, wherein the first communication protocol corresponds to Bluetooth and the second communication protocol corresponds to WiFi (wireless fidelity).

11. A method of an electronic device, the method comprising:
while performing communication with an external electronic device through a first communication link based on a first communication protocol, identifying that a communication connection of the first communication link has been interrupted;
based on information related to interruption of the communication connection, determining whether the first communication link is reconnectable within a designated time; and
in response to determining that reconnection of the first communication link within the designated time is impossible, connecting a second communication link based on a second communication protocol without waiting for the reconnection of the first communication link.

12. The method of claim 11, further comprising:
in response to determining that the reconnection of the first communication link within the designated time is possible, delaying connection of the second communication link, and waiting for the reconnection of the first communication link for the designated time.

13. The method of claim 11, further comprising:
in response to the reconnection of the first communication link not being performed before the designated time passes, connecting the second communication link based on the second communication protocol.

14. The method of claim 11, further comprising, based on the information related to interruption of the communication connection identifying that a message for communication interruption has been explicitly received from the external electronic device, determining that the reconnection of the first communication link within the designated time is impossible.

15. The method of claim 11, further comprising, based on the information related to interruption of the communication connection identifying that communication interruption has occurred due to failure in a different communication network of the external electronic device, waiting for the reconnection of the first communication link for the designated time.

16. The method of claim 11, further comprising identifying a user pattern, based on the information related to interruption of the communication connection, and in response to determining according to the user pattern that the reconnection of the first communication link within the designated time is impossible, connecting the second communication link based on the second communication protocol.

17. The method of claim 11, further comprising:
based on the information related to interruption of the communication connection identifying that a communication signal quality of a communication interruption time point is a designated level or higher, delaying connection of the second communication link and waiting for the reconnection of the first communication link for the designated time.

18. The method of claim 11, further comprising:
based on the information related to interruption of the communication connection identifying that the communication signal quality of the communication interruption time point is lower than the designated level, connecting the second communication link based on the second communication protocol without waiting for the reconnection of the first communication link.

19. The method of claim 11, wherein the information related to interruption of the communication connection comprises at least one of state information, app information, user behavior pattern information, message information, communication state information, communication quality information, or communication connection-related control information of the external electronic device.

20. The method of claim 11, wherein the first communication protocol corresponds to Bluetooth and the second communication protocol corresponds to WiFi (wireless fidelity).
